(19) United States
(12) Patent Application Publication
(10) Pub. No.: US 2015/0371299 A1
(43) Pub. Date: Dec. 24, 2015

(54) System and Method for Exchanging Books by Mail and In Person through a Secure Transfer of Funds

(71) Applicant: MIOARA IFRIM, N MIAMI BEACH, FL (US)

(72) Inventor: MIOARA IFRIM, N MIAMI BEACH, FL (US)

(21) Appl. No.: 14/311,641

(22) Filed: Jun. 23, 2014

(51) Int. Cl. G06Q 30/06; G06Q 20/02

(52) U.S. Cl. CPC G06Q 30/0609; G06Q 20/02

(57) ABSTRACT

A system and method for exchanging books through a secure transfer of funds by mail or in person. The system uses a common forum that enables the buyer to search for a book. The system also enables a second user who is in possession of the book, to search for and transact an exchange with the first user. An Internet System provides a platform for each user to interact with each other and the Internet System, a database to store book information for querying, a shipment tracking capacity, and a secure fund storage system that accepts and releases funds after predetermined conditions and a predetermined duration are met. The book can be mailed and transfer of funds occurs after delivery of shipment. The book can also be delivered in person, and transfer of funds occurs after buyer and seller exchange a verification code.

### BACKGROUND

It is known that college students are required to buy certain textbooks and specific course materials for the courses that they are enrolled in. These textbooks can be bought either in new or used condition at various bookstores. In some cases, other students who have previously taken the course may sell their textbooks to the students about to take the course.

The inventor was aware of the need to sell and buy used textbooks on the same college campus, or between different college campuses—often in different states. The inventor noticed that many textbook exchanges were not very smooth. The textbooks were not delivered as promised, either damaged, or simply the wrong textbook was sold. Additionally, since the buyer and seller usually didn't know each other, fraud and robberies would sometimes occur.

The inventor quickly recognized that there was a market for a safe method for exchanging the textbooks in which the funds would be held by a third party until the condition of the book and accuracy of the book order was confirmed. The inventor developed a website that linked to a database and other central processing units. The inventor added software that enables a secure way to hold money. In this way, a buyer could deposit money in this third party computer system until receiving the book.

However, the inventor soon realized that there was still fraud and misunderstandings involved. A duration of time and predetermined conditions were necessary before the funds could be transferred from buyer to seller through the computer system. The inventor required a twenty four hour period to elapse before the funds could be transferred. Additionally, the inventor required that mailed textbooks over a long distance would have to have a verifiable delivery before the funds could be transferred. This required adding shipping tracking software to the invention. This eliminated the risk for misunderstandings and fraud.

The inventor also decided to provide the buyer and seller with a secret verification code for personal deliveries of the book. They buyer and seller would exchange the verification code to indicate they were the rightful buyer and seller. This eliminated the risk of robberies.

Though there was still confusion in the exchange due to general ignorance of the textbook information. The inventor researched, and then decided to provide a forum for professors to interact with the buyer and seller. The professors could communicate the textbook information pertinent to the buyer, and also inform the seller which textbooks were needed by the buyer. This created a more accurate understanding by all parties as to which textbook was required and the pertinent book information that would make the exchange more efficient and secure.

Book exchange systems have been used for exchanging textbooks in the past, yet none with the present characteristics of the present invention. See patent numbers: U.S. Pat. No. 6,847,938; U.S. Pat. No. 8,498,907; and U.S. 20130268427.

For the foregoing reasons, there is a need for a system and method for exchanging books through a secure transfer of funds by mail or in person after predetermined conditions and durations were met, and involving an instructor that could provide information about the book to the buyer and seller.

### SUMMARY

The present invention is directed to a system and method for exchanging books through a secure transfer of funds by mail or in person. The system uses a common forum that enables the buyer to search for a book. The system also enables a second user who is in possession of the book, to search for and transact an exchange with the first user. The common forum through which all communications and transactions are performed is an Internet System. The Internet System provides a platform for each user to interact with each other and the Internet System, a database to store book information for querying, a shipment tracking capacity, and a secure fund storage system that accepts funds form the first user and releases funds to the second user after predetermined conditions are met.

Initially, the first user (buyer) queries book information and listing prices on a database of the Internet System. The second user (seller) provides this information by registering and inputting the book information into the database. The book information can include various categories, including, ISBN number, title, edition, region, school, subject matter, and professor. The first user searches the database for a book by manually querying book information from the database. However, if a unique book number, such as an ISBN number is entered, the Internet System automatically populates the book information. Once the first user identifies the desired book, the Internet System notifies both users about the match.

The system enables the exchange of books over longer distances, by mail; or from shorter distances, whereby the first user and second user meet in person to complete the transaction. Both types of exchanges are similar, except during the transfer of funds. In the mail delivery method, the funds are released after the delivery has been confirmed by the Internet System and the first user. In the personal delivery method, the Internet System assigns a unique code to the first user and the second user that must be matched by both users and verified by the Internet System before the funds are released. In either case, a predetermined duration passes before the funds are transferred to verify the accuracy and integrity of the book order.

One objective of the present invention is to remove fraud and misunderstandings form the exchange of books between two parties by having an intermediary that secures the funds for a duration until all parties are satisfied with the book and the agreed upon conditions have been met.

Another objective is to protect the first user from incorrect book purchases and damaged books.

Another objective is to provide a common forum that provides a platform for the users, stores book information, enables automated querying of the information, holds funds until predetermined conditions have been met, and tracks shipments of the book.

Another objective is to facilitate searching for a book by automatically populating book information if the ISBN number is known.

Yet another objective is to track shipments of the book, and not transfer funds until the shipment has been delivered.

Yet another objective is to provide the first user and the second user with a unique code to verify each other during the book exchange to confirm identity of each user.

Yet another objective is to protect the first user from incorrect book purchases and damaged books.

Yet another objective is to provide a low cost intermediary to facilitate and make more secure the exchange of books between users who may not know each other.

Yet another objective is to generate a profit by charging the first user and/or the second user a fee for transacting the book exchange.

Yet another objective is to involve an instructor in the transaction by enabling the instructor to inform the second user the book information that the first user may require.

### DRAWINGS

These and other features, aspects, and advantages of the present invention will become better understood with regard to the following description, appended claims, and drawings where:

FIG. 1 is a block diagram of a system for exchanging a book through a secure transfer of funds;

FIGS. 2A and 2B are flowchart diagrams for a method of exchanging a book by mail through a secure transfer of funds;

FIGS. 3A and 3B are flowchart diagrams for a method of exchanging a book by personally delivery through a secure transfer of funds; and

FIG. 4 is a block diagram depicting an exemplary client/server system which may be used by an exemplary web-enabled/networked embodiment of the present invention.

### DESCRIPTION

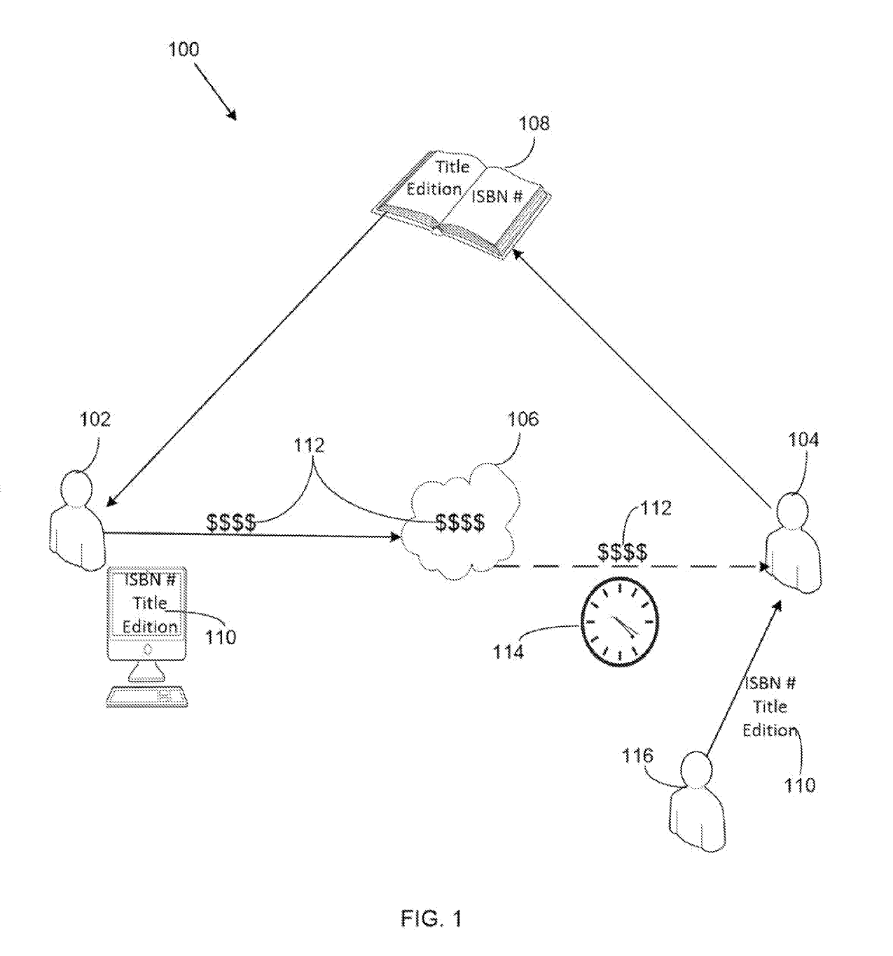

One embodiment, referenced in FIGS. 1A-4, illustrates a system 100 and method 200, 300 for enabling a first user 102 (buyer), and a second user 104 (seller), to exchange a book 108 through a common forum that provides a communication point for the users, facilitated querying of book information 110, and a secure transfer of funds 112. The system 100 and method 200, 300 may be operable to enable the first user 102 and the second user 104 to securely and accurately perform the exchange by mail or in person, while having funds 112 securely transferred after predetermined conditions and a predetermined duration 114 have been met.

As referenced in FIG. 1, a system 100 for exchanging funds 112 uses a common forum that enables the buyer, or first user 102, to search for a book 108. The system 10 also enables a second user 104 who is in possession of the book 108, to search for and transact an exchange with the first user 102. The common forum through which all communications and transactions are performed is an Internet System 106. The Internet System 106 provides a platform for each user 102, 104 to interact with each other and the Internet System 106, a database to store and query for book information 110, a shipment tracking capacity, and a secure fund storage system that accepts funds 112 form the first user 102 and releases funds 112 to the second user 104 after predetermined conditions and a predetermined duration 114 are met. The Internet System 106 may include, without limitation, a website, a server, a database, a cloud, a network, a central processing unit, a mobile device, and encrypted software used to securely hold and transfer funds 112.

Initially in the system 100, the first user 102 queries book information 110 and listing prices on a database of the Internet System 106. The second user 104 provides the book information 110 by registering and inputting the book information 110 into the database. The book information 110 can include various categories, including, without limitation, ISBN number, title, edition, region, school, subject matter, and professor. The first user 102 searches the database for the desired book 108 by manually querying book information 110 from the database. However, if a unique book 108 number is entered by the first user, the Internet System 106 automatically populates the book information 110.

Those skilled in the art will recognize that the International Standard Book Number (ISBN) is a unique numeric commercial book identifier based upon the 9-digit Standard Book Numbering (SBN) code. The ISBN is assigned to each edition and variation of a unique book. For example, an eBook, a paperback, and a hardcover edition of the same book would each have a different ISBN number. In the present invention, the unique book number is the ISBN, whereby the first user 102 can enter the ISBN and the Internet System 106 automatically populates the remaining portion of the book information 110, such as title, edition, author, and the like. This automated population feature facilitates the search for the desired book 108 by the first user 102. In either case however, once the first user 102 identifies the desired book 108, the Internet System 106 notifies both users 102, 104 about the match.

In some embodiments, the system 100 may enable the exchange of the book 108 over longer distances, by mail; or from shorter distances, whereby the first user 102 and the second user 104 meet in person to complete the transaction. Both types of exchanges are substantially similar, except for the means to verify and confirm the accuracy of the book 108 in the transaction. In the mail delivery method 200, the funds 112 are released after the delivery has been confirmed by the Internet System 106 and the first user 102. For example, without limitation, the first user 102 deposits funds 112 into the Internet System 106. The second user 104 is notified of the deposit by the Internet System 106, and mails the book 108 through the postal service. The postal service provides the book 108 with a tracking number. The first user 102 and the Internet System 106 are provided with the tracking number to track the book 108 during shipment and to confirm arrival. The Internet System 106 releases the funds 112 after a predetermined duration 114. The predetermined duration 114 may include a twenty four hour period after the delivery of the book 108. The twenty four hour period provides sufficient time for the first user 102 to inspect the book 108 and verify accuracy and check for damage to the book 108. If the first user 102 is not satisfied with the book 108, the funds are not transferred to the second user 104 until the problem is resolved.

In the personal delivery method 300, the Internet System 106 assigns a unique code to the first user 102 and the second user 104 that must be matched by both users 102, 104 and verified by the Internet System 106 before the funds 112 are released. In either case, a predetermined duration 114 passes before the funds 112 are transferred to verify the accuracy and integrity of the book order. For example, without limitation, the Internet System 106 provides the first user 102 and the second user 104 with a verification code. The first user 102 deposits the funds 112 into the Internet System 106. After the second user 104 delivers the book 108 to the first user 102, and the codes are confirmed, the Internet System 106 transfers the funds 112 to the second user 104. The twenty four hour duration 114 before releasing the funds 112 may not be as necessary for the personal delivery method 300; though may still be used.

In one embodiment, the system 100 for exchanging a book 108 may be efficacious for exchanging, buying, and selling the book 108 and pertinent information about the book 108 between different college campuses or a single college campus. The system 100 and method 200, 300 can be used to enable college students to exchange college textbooks and pertinent information about the textbooks in a common forum, such as on the Internet System 106. The funds 112 are retained and released by the system 106 after confirmation of predetermined conditions and a predetermined duration 114 have been determined by all parties involved. In one alternative embodiment, an instructor 116 communicates instructions to the second user 104 identifying book information 110 that may be pertinent to the first user 102. The instructor 116 can also be helpful to the first user 102 by recommending specific editions of the book 108, and important chapters for study.

However, in other embodiments, the system 100 can be used to exchange any type of book 108, including, without limitation, magazines, religious literature, user's manual, or product instructions. In yet another embodiment, the system 100 may be used between schools and book publishers. In yet another alternative embodiment, the system 100 can be used between a first user 102 and a second user 104 in different countries, whereby the Internet System 106 converts currencies received by the first user 102 and transfers the funds 112 to the second user 104.

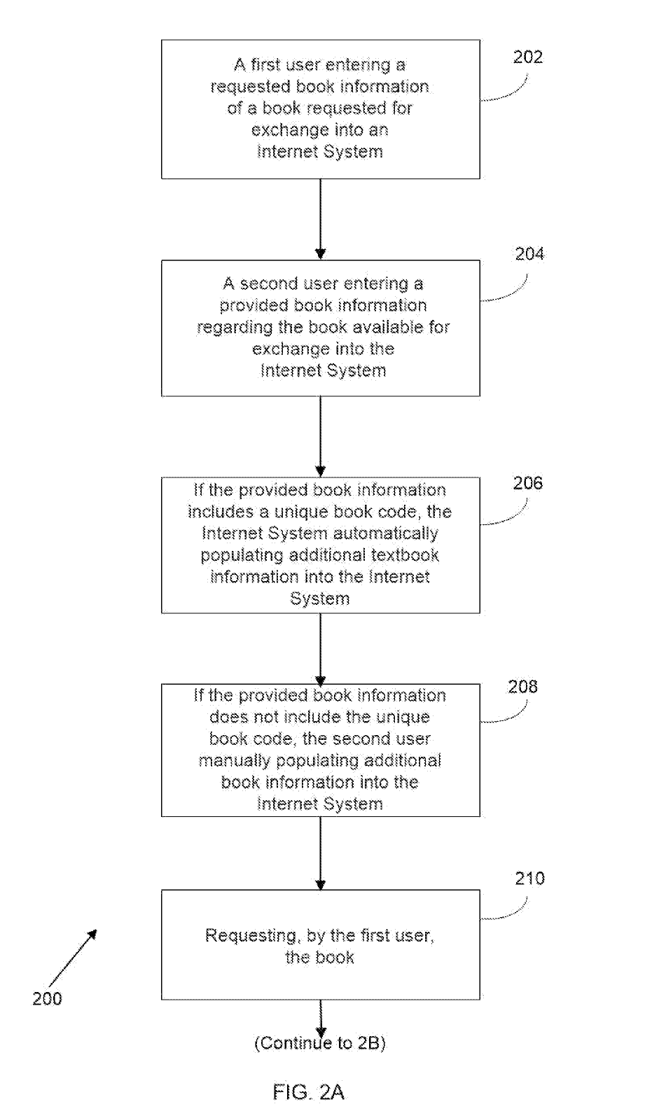

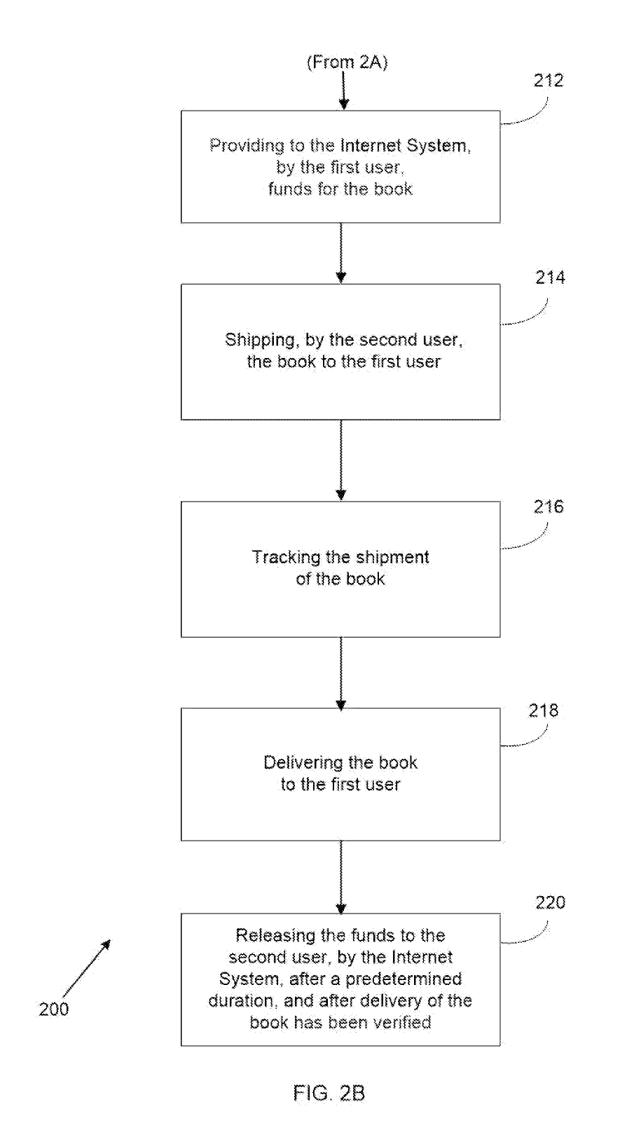

FIGS. 2A and 2B illustrate a method 200 of exchanging a book 108 by mail through a secure transfer of funds 112. The method 200 is performed through an Internet System 106 that provides a secure exchange of funds 112 after predetermined conditions have been met. The method 200 includes a first Step 202 of a first user 102 entering a requested book information 110 of the book 108 requested for exchange into an Internet System 106. The first user 102 queries book information 110 and listing prices on a database of the Internet System 106. The book information 110 can include various categories, including, ISBN number, title, edition, region, school, subject matter, and professor. The first user 102 searches the database for the book 108 by manually querying the book information 110 from a database in the Internet System 106.

A next Step 204 may include a second user 104 entering a provided book information 110 regarding the book 108 available for exchange into the Internet System 106. The second user 104 provides the book information 110 by registering and inputting the book information 110 into the database. However, if the provided book information 110 includes a unique book code, a Step 206 comprises the Internet System 106 automatically populating additional book information 110 into the Internet System 106. This automated population feature facilitates the search for the desired book 108 by the first user 102. But if the provided book information 110 does not include the unique book code, a Step 208 includes the second user 104 manually populating additional book information 110 into the Internet System 106. In either case however, once the first user 102 identifies the desired book 108, the Internet System 106 notifies both users 102, 104 about the match.

In some embodiments, the method may further include a Step 210 of requesting, by the first user 102, the book 108. A Step 212 includes providing to the Internet System 106, by the first user 102, funds 112 for the book 108. The first user 102 deposits the funds 112 directly into the Internet System 106. The Internet System 106 may retain a percentage of the funds 112 to generate revenue for the system 106. A Step 214 may include shipping, by the second user 104, the book 108 to the first user 102. The second user 104 may use the postal service or a private delivery company. In either case, a tracking number is provided for the shipment of the book 108.

In some embodiments, the method 200 may include a Step 216 of tracking the shipment of the book 108. In the mail delivery method 200, the funds 112 are released after the delivery has been confirmed by the Internet System 106 and the first user 102, and a predetermined duration 114 has lapsed. The postal service or private delivery company provides a tracking number that is monitored by the first user 102 and the Internet System 106 to indicate the status of the delivery and when the book 108 has been delivered. Another Step 218 may include delivering the book 108 to the first user 102. The delivery of the book 108 is one of the predetermined conditions necessary to release the funds 112 to the second user 104. A final Step 220 comprises releasing the funds 112 to the second user 104 by the Internet System 106 after a predetermined duration 114, and after delivery of the book 108 has been verified. The predetermined duration 114 can be a twenty four hour period that provides a lapse of time for the first user 102 to inspect the book 108 and verify accuracy and check for damage. If the first user 102 is not satisfied with the book 108, the funds are not transferred to the second user 104 until the issue is resolved.

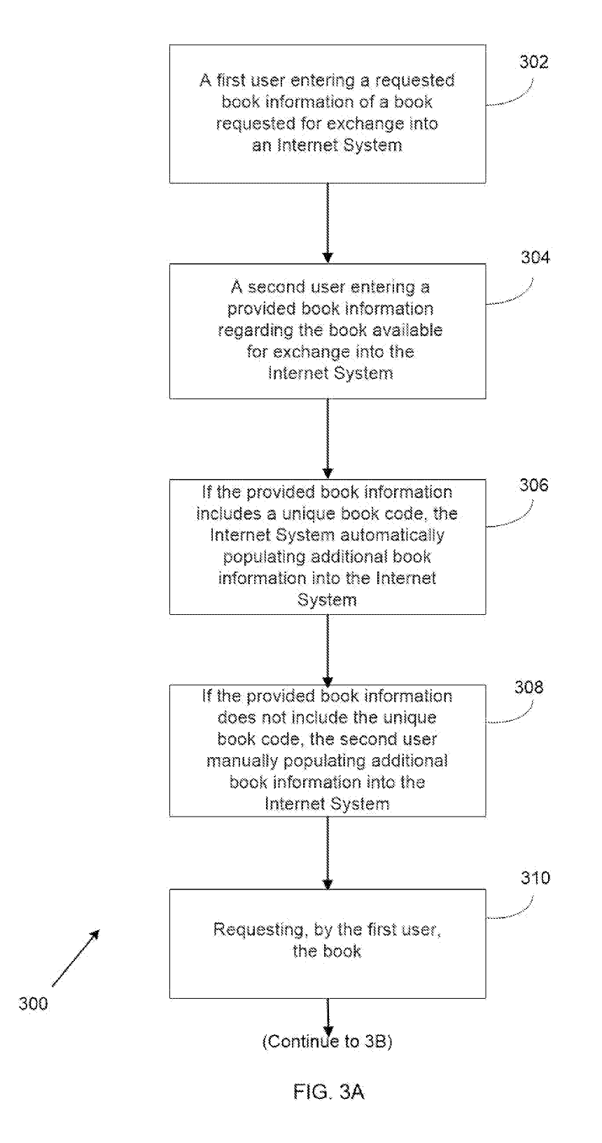

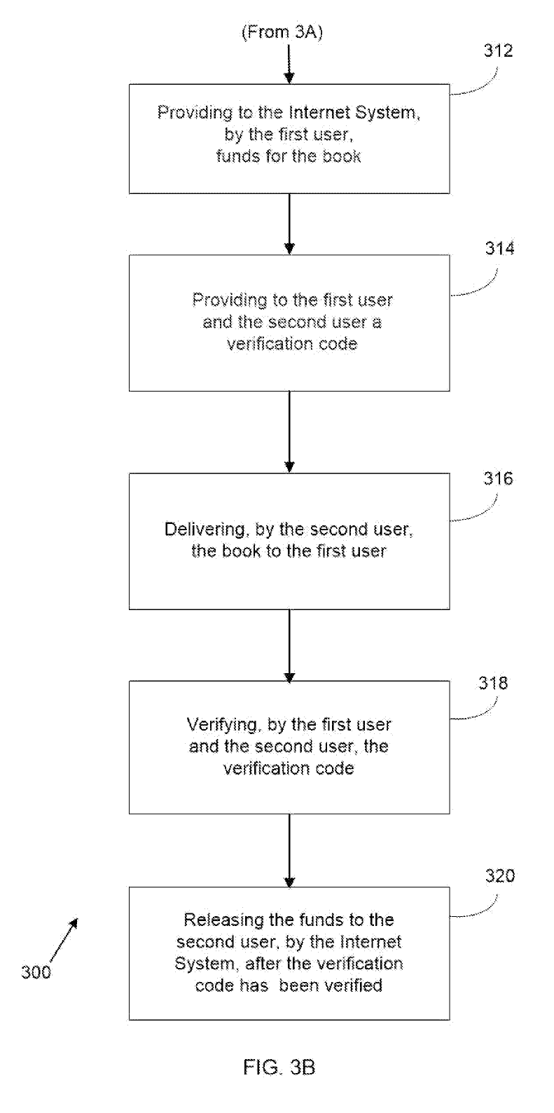

FIGS. 3A and 3B show a method 300 of exchanging a book 108 in person, rather than by mail, through a secure transfer of funds. The method 300 of exchanging the book 108 by delivery in person is similar to the method 200 of exchanging the book 108 by mail, except that the verification process needed to transfer the funds 112 is different. The method 300 of exchanging the book 108 in person is performed through the Internet System 106 and provides a secure exchange of funds 112 after predetermined conditions have been met. The method 300 includes a first Step 302 of a first user 102 entering a requested book information 110 of the book 108 requested for exchange into an Internet System 106. The first user 102 queries book information 110 and listing prices on a database of the Internet System 106. The book information 110 can include various categories, including, ISBN number, title, edition, region, school, subject matter, and professor.

A next Step 304 may include a second user 104 entering a provided book information 110 regarding the book 108 available for exchange into the Internet System 106. The second user 104 provides the book information 110 by registering and inputting the book information 110 into the database. However, if the provided book information 110 includes a unique book code, a Step 306 comprises the Internet System 106 automatically populating additional book information 110 into the Internet System 106. This automated population feature facilitates the search for the desired book 108 by the first user 102. But if the provided book information 110 does not include the unique book code, a Step 308 includes the second user 104 manually populating additional book information 110 into the Internet System 106. In either case however, once the first user 102 identifies the desired book 108, the Internet System 106 notifies both users about the match.

In some embodiments, the method may further include a Step 310 of requesting, by the first user 102, the book 108. In some embodiments, a Step 312 includes providing to the Internet System 106, by the first user 102, funds 112 for the book 108. The Internet System 106 may retain a percentage of the funds 112 to generate revenue for the system 100. A Step 314 may include providing to the first user 102 and the second user 104 a verification code. The verification code can include any set of alpha numerals known only by the first and second users 102, 104. The method may include a Step 316 of delivering, by the second user 104, the book 108 to the first user 102. The second user 104 is in proximity to the first user 102, such that personal delivery is more advantageous than mailing the book 108.

Another Step 318 may include verifying, by the first user 102 and the second user 104, the verification code. This confirmation of the verification code is one of the predetermined conditions in the method 300. A final Step 320 comprises releasing the funds 112 to the second user 104, by the Internet System 106, after the verification code has been verified. After the second user 104 delivers the book 108 to the first user 102, the Internet System 106 transfers the funds 112 to the second user 104. The predetermined duration 114 of twenty four hours before releasing the funds 112 may not be necessary for the personal delivery method 300; though may still be used.

The methods 200, 300 can be used to exchange the book 108 over longer distances, by mail; or from shorter distances, whereby the first user 102 and the second user 104 meet in person to complete the transaction. Both types of exchanges are similar, except in the means for verifying accuracy of the book order and condition of the book 108. Also, a predetermined duration 114 passes before the funds 112 are transferred to verify the accuracy and integrity of the book order. In the former, the funds 112 are released after the delivery has been confirmed by all parties. In the latter, the first user 102 and the second user 104 must exchange a verification code, provided by the Internet System 106 for the funds 112 to be released.

In one alternative embodiment, an instructor 116, such as a college professor can indicate/recommend the appropriate textbook 108 for college students to purchase, and relative information about a college textbook, such as content, suggested price, and future lesson plans. All parties involved in the transaction exchange information about the textbooks through an exchange forum, such as a website linked to a server. Purchases can include monetary payment, bartering, or other agreed upon forms of compensation, including borrowing the textbook for a semester.

In some embodiments, the common forum used by the system 100 is a website that enables the students to search for textbook and potential buyers of the textbooks by various categories, including, region, school, subject matter, and professor. The website is viewable and accessible by all parties. The information about the textbooks is stored in a central database. There are various ways that the system 100 could generate revenue. In one possible embodiment, the system 100 receives a percentage of each transaction from the first user 102 and/or second user 104. In another technique, all parties pay a membership fee to join the forum and exchange information and textbooks. In yet another embodiment, the second user 104 pays to have the textbook displayed on the website and sold.

In one alternative embodiment, the system 100 and method 200, 300 creates a more efficient marketplace for exchanging textbooks on a college campus by involving an instructor 116, such as a college professor in the transaction. In one example, the instructor 116 informs the students with a textbook that the textbook is in its final edition. The price of the textbook is consequently reduced. The transaction between students can also be adjusted according to the information provided by the instructor 116. The buying student receives the textbook for a reduced price. The system 100 may then receive a percentage of the transaction.

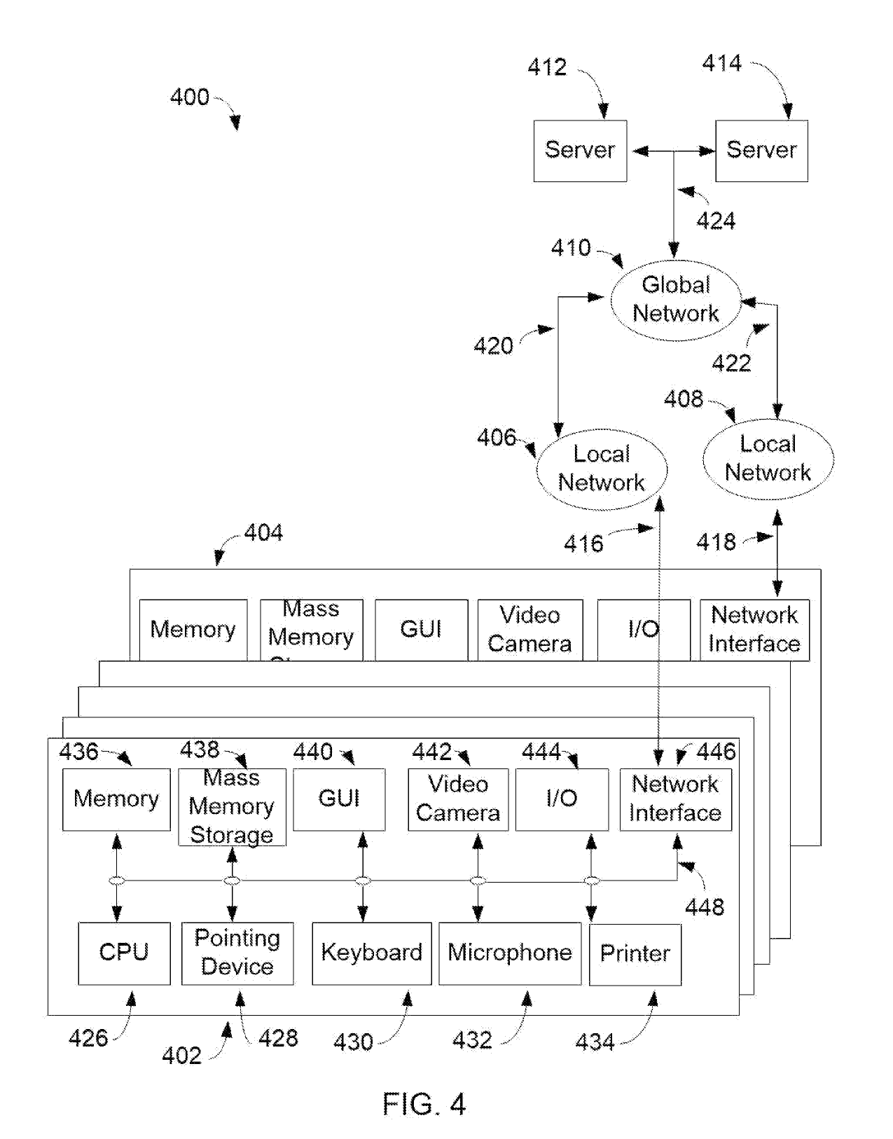

FIG. 4 is a block diagram depicting an exemplary client/server system which may be used by an exemplary web-enabled/networked embodiment of the present invention. A communication system 400 includes a multiplicity of clients with a sampling of clients denoted as a client 402 and a client 404, a multiplicity of local networks with a sampling of networks denoted as a local network 406 and a local network 408, a global network 410 and a multiplicity of servers with a sampling of servers denoted as a server 412 and a server 414.

Client 402 may communicate bi-directionally with local network 406 via a communication channel 416. Client 404 may communicate bi-directionally with local network 408 via a communication channel 418. Local network 406 may communicate bi-directionally with global network 410 via a communication channel 420. Local network 408 may communicate bi-directionally with global network 410 via a communication channel 422. Global network 410 may communicate bi-directionally with server 412 and server 414 via a communication channel 424. Server 412 and server 414 may communicate bi-directionally with each other via communication channel 424. Furthermore, clients 402, 404, local networks 406, 408, global network 410 and servers 412, 414 may each communicate bi-directionally with each other.

In one embodiment, global network 410 may operate as the Internet. It will be understood by those skilled in the art that communication system 400 may take many different forms. Non-limiting examples of forms for communication system 400 include local area networks (LANs), wide area networks (WANs), wired telephone networks, wireless networks, or any other network supporting data communication between respective entities.

Clients 402 and 404 may take many different forms. Non-limiting examples of clients 402 and 404 include personal computers, personal digital assistants (PDAs), cellular phones and smartphones.

Client 402 includes a CPU 426, a pointing device 428, a keyboard 430, a microphone 432, a printer 434, a memory 436, a mass memory storage 438, a GUI 440, a video camera 442, an input/output interface 444 and a network interface 446.

CPU 426, pointing device 428, keyboard 430, microphone 432, printer 434, memory 436, mass memory storage 438, GUI 440, video camera 442, input/output interface 444 and network interface 446 may communicate in a unidirectional manner or a bi-directional manner with each other via a communication channel 448. Communication channel 448 may be configured as a single communication channel or a multiplicity of communication channels.

CPU 426 may be comprised of a single processor or multiple processors. CPU 426 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 436 is used typically to transfer data and instructions to CPU 426 in a bi-directional manner. Memory 436, as discussed previously, may include any suitable computer-readable media, intended for data storage, such as those described above excluding any wired or wireless transmissions unless specifically noted. Mass memory storage 438 may also be coupled bi-directionally to CPU 426 and provides additional data storage capacity and may include any of the computer-readable media described above. Mass memory storage 438 may be used to store programs, data and the like and is typically a secondary storage medium such as a hard disk. It will be appreciated that the information retained within mass memory storage 438, may, in appropriate cases, be incorporated in standard fashion as part of memory 436 as virtual memory.

CPU 426 may be coupled to GUI 440. GUI 440 enables a user to view the operation of computer operating system and software. CPU 426 may be coupled to pointing device 428. Non-limiting examples of pointing device 428 include computer mouse, trackball and touchpad. Pointing device 428 enables a user with the capability to maneuver a computer cursor about the viewing area of GUI 440 and select areas or features in the viewing area of GUI 440. CPU 426 may be coupled to keyboard 430. Keyboard 430 enables a user with the capability to input alphanumeric textual information to CPU 426. CPU 426 may be coupled to microphone 432. Microphone 432 enables audio produced by a user to be recorded, processed and communicated by CPU 426. CPU 426 may be connected to printer 434. Printer 434 enables a user with the capability to print information to a sheet of paper. CPU 426 may be connected to video camera 442. Video camera 442 enables video produced or captured by user to be recorded, processed and communicated by CPU 426.

CPU 426 may also be coupled to input/output interface 444 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 426 optionally may be coupled to network interface 446 which enables communication with an external device such as a database or a computer or telecommunications or internet network using an external connection shown generally as communication channel 416, which may be implemented as a hardwired or wireless communications link using suitable conventional technologies. With such a connection, CPU 426 might receive information from the network, or might output information to a network in the course of performing the method steps described in the teachings of the present invention.

While the inventor's above description contains many specificities, these should not be construed as limitations on the scope, but rather as an exemplification of several preferred embodiments thereof. Many other variations are possible. For example, the system could be used between a first user 102 and a second user 104 in different countries, whereby the system 100 not only holds the funds 112, but converts the funds 112 into the appropriate currency. Accordingly, the scope should be determined not by the embodiments illustrated, but by the appended claims and their legal equivalents.

What is claimed is:

1. One or more computer storage media storing computer-usable instructions, that when used by one or more computing devices, cause the one or more computing devices to perform a method of exchanging books by mail through an Internet System that provides a secure exchange of funds after predetermined conditions have been met, the method comprising:
a first user entering a requested book information of a book requested for exchange into an Internet System;
a second user entering a provided book information regarding the book available for exchange into the Internet System;
if the provided book information includes a unique book code, the Internet System automatically populating additional book information into the Internet System;
if the provided book information does not include the unique book code, the second user manually populating additional book information into the Internet System;
requesting, by the first user, the book;
providing to the Internet System, by the first user, funds for the book;
shipping, by the second user, the book to the first user;
tracking the shipment of the book;
delivering the book to the first user; and
releasing the funds to the second user, by the Internet System, after a predetermined duration, and after delivery of the book has been verified.

2. The method of claim 1, further including a step of an instructor communicating the requested book information to the first user.

3. The method of claim 2, wherein the instructor communicates instructions to the second user identifying the first user to whom the book exchange should be made.

4. The method of claim 3, wherein the unique book code is an ISBN number.

5. The method of claim 4, wherein the provided book information is at least a book ISBN number and a condition of each book.

6. The method of claim 5, wherein the predetermined duration is twenty four hours.

7. The method of claim 6, wherein the book is a college textbook.

8. One or more computer storage media storing computer-usable instructions, that when used by one or more computing devices, cause the one or more computing devices to perform a method of exchanging books in person through an Internet System that provides a secure exchange of funds after predetermined conditions have been met, the method comprising:
a first user entering a requested book information of a book requested for exchange into an Internet System;
a second user entering a provided book information regarding the book available for exchange into the Internet System;
if the provided book information includes a unique book code, the Internet System automatically populating additional book information into the Internet System;
if the provided book information does not include the unique book code, the second user manually populating additional book information into the Internet System;
requesting, by the first user, the book;
providing to the Internet System, by the first user, funds for the book;
providing to the first user and the second user a verification code;
delivering, by the second user, the book to the first user;
verifying, by the first user and the second user, the verification code; and
releasing the funds to the second user, by the Internet System, after the verification code has been verified.

9. The method of claim 8, further including a step of an instructor communicating the requested book information to the first user.

10. The method of claim 9, wherein the instructor communicates instructions to the second user identifying the first user to whom the book exchange should be made.

11. The method of claim 10, wherein the unique book code is an ISBN number.

12. The method of claim 11, wherein the provided book information is at least a book ISBN number and a condition of each book.

13. The method of claim 12, wherein the predetermined duration is twenty four hours.

14. The method of claim 13, wherein the book is a college textbook.
